(19) United States
(12) Patent Application Publication
(10) Pub. No.: US 2026/0205372 A1
(43) Pub. Date: Jul. 16, 2026

(54) SYSTEMS AND METHODS FOR DETERMINING NETWORK PATHS AND ELIMINATING CHANNEL REDUNDANCY USING ARTIFICIAL INTELLIGENCE AND QUANTUM KNOWLEDGE GRAPHING

(71) Applicant: BANK OF AMERICA CORPORATION, Charlotte, NC (US)

(72) Inventors: Pushkar Taneja, Hyderabad (IN); Swetha Anand, Mumbai (IN); Naveen Kumar Gujjarlamudi, Visakhapatnam (IN); Krishna Kolli, Hyderabad (IN); Tarminder Kumar, Nagar Mohali (IN); Naman Kaur Makkar, New Delhi (IN); Santhosh Mekala, Hyderabad (IN); Yuvaraju Nataraj, Hyderabad (IN); Pranali Shridhar Patil, Navi Mumbai (IN); Rachuri Ravi Teja, Hyderabad (IN)

(73) Assignee: BANK OF AMERICA CORPORATION, Charlotte, NC (US)

(21) Appl. No.: 19/022,354

(22) Filed: Jan. 15, 2025

(51) Int. Cl. H04L 41/16; H04L 41/06; H04L 41/12; H04L 47/125

(52) U.S. Cl. CPC H04L 41/16; H04L 41/12; H04L 47/125; H04L 41/06

(57) ABSTRACT

Systems, computer program products, and methods are described herein for determining network paths and eliminating channel redundancy using artificial intelligence (AI) and quantum knowledge graphing. The present disclosure is configured to receive and extract network data from one or more network path transmission requests and identify network channel requirements based on at least the network data. The system executes a network scan based on at least the network channel requirements and determines a network channel status for one or more network channels based on at least the network channel requirements. The present disclosure is also configured to generate a network channel matrix based on at least the spatial network relationship map. Furthermore, the present disclosure is configured to determine, using the AI engine, a determined network channel based on the network channel matrix. In addition, the present disclosure is configured to generate and transmit a determined network channel notification.

### TECHNOLOGICAL FIELD

Example embodiments of the present disclosure relate to determining network paths and eliminating channel redundancy using artificial intelligence (AI) and quantum knowledge graphing.

### BACKGROUND

Determining network paths and eliminating channel redundancy presents challenges due to security requirements, latency issues, and managing network resources. For example, detecting changes to network channels, identifying secure parallel network channels, ensuring secure network data transmissions, and managing network resources in real-time is technically complex, requires adaptive network infrastructure, and dynamic monitoring and adaptive actions. Establishing redundant systems may facilitate setup of parallel network channels, but parallel network channels can lead to poor network resource utilization and allocation. Improper network channel allocation and monitoring yields unbalanced network device and network channel workloads and impacts security of network transmissions. In addition, distributed systems provide multiple communications channels and network channels due to various connection points, which may add more network channel bandwidth. However, this can result in nodes task-switching frequently between the various communications channels and network channels due to poor node management, leading to decreased network performance, increased latencies, and increased network data transmission errors. In addition, firewalls may be configured to log all network activity to improve security of network channels, but this leads to continuously logging trusted activities and rechecking safe connections, resulting in degraded network monitoring performance.

Applicant has identified a number of deficiencies and problems associated with determining network paths and eliminating channel redundancy using AI and quantum knowledge graphing. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for determining network paths and eliminating channel redundancy using AI and quantum knowledge graphing.

In one aspect, a system for determining network paths and eliminating channel redundancy using AI and quantum knowledge graphing is provided. In some embodiments, the system may comprise a memory device with computer-readable program code stored thereon; at least one processing device, wherein executing the computer-readable program code is configured to cause the at least one processing device to execute the computer-readable program code to: receive and extract network data from one or more network path transmission requests; identify network channel requirements based on at least the network data; execute a network scan based on at least the network channel requirements; determine a network channel status for one or more network channels based on at least the network channel requirements; generate a spatial network relationship map based on at least one of the network channel status and the network channel requirements; execute, using the AI engine, a network anomaly protocol based on at least one of the spatial network relationship map, the network channel status, and the network channel requirements; generate a network channel matrix based on at least the spatial network relationship map; determine, using the AI engine, a determined network channel based on the network channel matrix; and generate and transmit a determined network channel notification.

In some embodiments, executing the computer-readable program code is further configured to cause the at least one processing device to: execute, via the AI engine, an authentication protocol of the one or more network path transmission requests associated with one or more network devices in the determined network channel; execute, via the AI engine, a geographic verification protocol of the one or more network path transmission requests; execute, via the AI engine, an encryption protocol of the one or more network path transmission requests; execute, via the AI engine, a log validation protocol of the one or more network path transmission requests; execute, via the AI engine, a memory allocation protocol of the of the one or more network path transmission requests; identify, via the AI engine, an additional network path transmission request associated with the one or more network path transmission requests; determine, via the AI engine, to intercept the one or more network path transmission requests based on the additional network path transmission request; generate and transmit an interception notification; and execute, via the AI engine, a network resource load rebalancing.

In some embodiments, executing the computer-readable program code is further configured to cause the at least one processing device to: verify, using the AI engine, configurations of one or more network devices in the determined network channel; verify, using the AI engine, certificates associated with the one or more network devices in the determined network channel; authenticate, using the AI engine, the one or more network devices in the determined network channel via batch authentication; execute, via the AI engine, network trusted authentication to authenticate the one or more network devices in the determined network channel; authenticate, using the AI engine, the one or more network devices in the determined network channel via token authentication; identify, via the AI engine, an execution validation of the authentication protocol; and generate and transmit an authentication protocol validation message.

In some embodiments, executing the computer-readable program code is further configured to cause the at least one processing device to: generate a user interface on a display; render one or more interactive interface elements within the user interface, wherein the one or more interactive interface elements comprise the spatial network relationship map; and receive control signals from at least one device to navigate the one or more interactive interface elements, wherein the spatial network relationship map comprises a quantum knowledge graph.

In some embodiments, the network anomaly protocol further comprises a particle swarm optimization model configured to scan audit logs, identify signatures and patterns, monitor previous network transmission requests, monitor increases and decreases in network traffic, determine irregular patterns in network packets, and determine a rules criteria threshold associated with rules data.

In some embodiments, executing the computer-readable program code is further configured to cause the at least one processing device to: receive at least one historical dataset; train the AI engine based on the at least one historical dataset; receive network packet vulnerability data; update the at least one historical dataset with the network packet vulnerability data; and retrain the AI engine based on the network packet vulnerability data.

In some embodiments, executing the computer-readable program code is further configured to cause the at least one processing device to: detect, via the AI engine, one or more network anomalies; segment the one or more network anomalies; determine, via the AI engine, network anomaly remediations; and transmit the network anomaly remediations via notification.

In some embodiments, executing the computer-readable program code is further configured to cause the at least one processing device to: determine, using the AI engine, an alternative network channel associated with the network path transmission request; and generate a network path linkage based on the alternative network channel.

In some embodiments, the network channel matrix further comprises a network channel label, network path transmission threshold, last detected anomaly timestamp, security criteria, network channel maintenance timestamp, network channel activity threshold, and network path length.

In some embodiments, executing the computer-readable program code is further configured to cause the at least one processing device to: detect, via the AI engine, one or more network anomalies; segment the one or more network anomalies; determine, via the AI engine, network anomaly remediations; and transmit the network anomaly remediations via notification.

In another aspect, a computer program product for determining network paths and eliminating channel redundancy using artificial intelligence and quantum knowledge graphing, wherein the computer program product comprises at least one non-transitory computer-readable medium having computer-readable program code portion embodied therein, the computer-readable program code portions which when executed by a processing device are configured to cause a processor to: receive and extract network data from one or more network path transmission requests; identify network channel requirements based on at least the network data; execute a network scan based on at least the network channel requirements; determine a network channel status for one or more network channels based on at least the network channel requirements; generate a spatial network relationship map based on at least one of the network channel status and the network channel requirements; execute, using the AI engine, a network anomaly protocol based on at least one of the spatial network relationship map, the network channel status, and the network channel requirements; generate a network channel matrix based on at least the spatial network relationship map; determine, using the AI engine, a determined network channel based on the network channel matrix; and generate and transmit a determined network channel notification.

In some embodiments, the processing device is further configured to: execute, via the AI engine, an authentication protocol of the one or more network path transmission requests associated with one or more network devices in the determined network channel; execute, via the AI engine, a geographic verification protocol of the one or more network path transmission requests; execute, via the AI engine, an encryption protocol of the one or more network path transmission requests; execute, via the AI engine, a log validation protocol of the one or more network path transmission requests; execute, via the AI engine, a memory allocation protocol of the of the one or more network path transmission requests; identify, via the AI engine, an additional network path transmission request associated with the one or more network path transmission requests; determine, via the AI engine, to intercept the one or more network path transmission requests based on the additional network path transmission request; generate and transmit an interception notification; and execute, via the AI engine, a network resource load rebalancing.

In some embodiments, the processing device is further configured to: verify, using the AI engine, configurations of one or more network devices in the determined network channel; verify, using the AI engine, certificates associated with the one or more network devices in the determined network channel; authenticate, using the AI engine, the one or more network devices in the determined network channel via batch authentication; execute, via the AI engine, network trusted authentication to authenticate the one or more network devices in the determined network channel; authenticate, using the AI engine, the one or more network devices in the determined network channel via token authentication; identify, via the AI engine, an execution validation of the authentication protocol; and generate and transmit an authentication protocol validation message.

In some embodiments, the processing device is further configured to: generate a user interface on a display; render one or more interactive interface elements within the user interface, wherein the one or more interactive interface elements comprise the spatial network relationship map; and receive control signals from at least one device to navigate the one or more interactive interface elements, wherein the spatial network relationship map comprises a quantum knowledge graph.

In some embodiments, the network anomaly protocol further comprises a particle swarm optimization model configured to scan audit logs, identify signatures and patterns, monitor previous network transmission requests, monitor increases and decreases in network traffic, determine irregular patterns in network packets, and determine a rules criteria threshold associated with rules data.

In some embodiments, network channel matrix further comprises a network channel label, network path transmission threshold, last detected anomaly timestamp, security criteria, network channel maintenance timestamp, network channel activity threshold, and network path length.

In some embodiments, the processing device is further configured to: determine, using the AI engine, an alternative network channel associated with the network path transmission request; and generate a network path linkage based on the alternative network channel.

In another aspect, computer-implemented method for determining network paths and eliminating channel redundancy using artificial intelligence and quantum knowledge graphing: receiving and extracting network data from one or more network path transmission requests; identifying network channel requirements based on at least the network data; executing a network scan based on at least the network channel requirements; determining a network channel status for one or more network channels based on at least the network channel requirements; generating a spatial network relationship map based on at least one of the network channel status and the network channel requirements; executing, using the AI engine, a network anomaly protocol based on at least one of the spatial network relationship map, the network channel status, and the network channel requirements; generating a network channel matrix based on at least the spatial network relationship map; determining, using the AI engine, a determined network channel based on the network channel matrix; and generating and transmitting a determined network channel notification.

In some embodiments, the computer-implemented method is further configured for: executing, via the AI engine, an authentication protocol of the one or more network path transmission requests associated with one or more network devices in the determined network channel; executing, via the AI engine, a geographic verification protocol of the one or more network path transmission requests; executing, via the AI engine, an encryption protocol of the one or more network path transmission requests; executing, via the AI engine, a log validation protocol of the one or more network path transmission requests; executing, via the AI engine, a memory allocation protocol of the of the one or more network path transmission requests; identifying, via the AI engine, an additional network path transmission request associated with the one or more network path transmission requests; determining, via the AI engine, to intercept the one or more network path transmission requests based on the additional network path transmission request; generating and transmitting an interception notification; and executing, via the AI engine, a network resource load rebalancing.

In some embodiments, the computer-implemented method is further configured for: verifying, using the AI engine, configurations of one or more network devices in the determined network channel; verifying, using the AI engine, certificates associated with the one or more network devices in the determined network channel; authenticating, using the AI engine, the one or more network devices in the determined network channel via batch authentication; executing, via the AI engine, network trusted authentication to authenticate the one or more network devices in the determined network channel; authenticating, using the AI engine, the one or more network devices in the determined network channel via token authentication; identifying, via the AI engine, an execution validation of the authentication protocol; and generating and transmitting an authentication protocol validation message.

In some embodiments, the computer-implemented method is further configured for: generating a user interface on a display; rendering one or more interactive interface elements within the user interface, wherein the one or more interactive interface elements comprise the spatial network relationship map; and receiving control signals from at least one device to navigate the one or more interactive interface elements, wherein the spatial network relationship map comprises a quantum knowledge graph.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining network paths and eliminating channel redundancy using AI and quantum knowledge graphing in accordance with an embodiment of the disclosure;

FIG. 2 illustrates an exemplary AI engine subsystem architecture, in accordance with an embodiment of the disclosure;

FIG. 3 illustrates an exemplary generative AI engine subsystem architecture, in accordance with an embodiment of the disclosure;

FIG. 2 illustrates an exemplary AI engine subsystem architecture, in accordance with an embodiment of the disclosure;

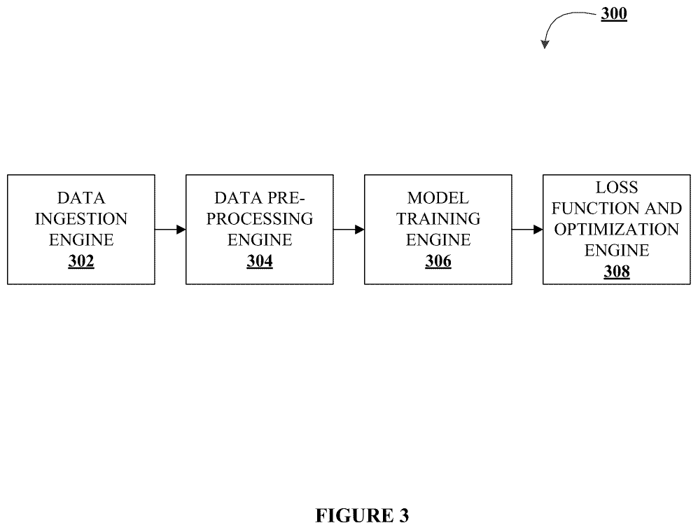

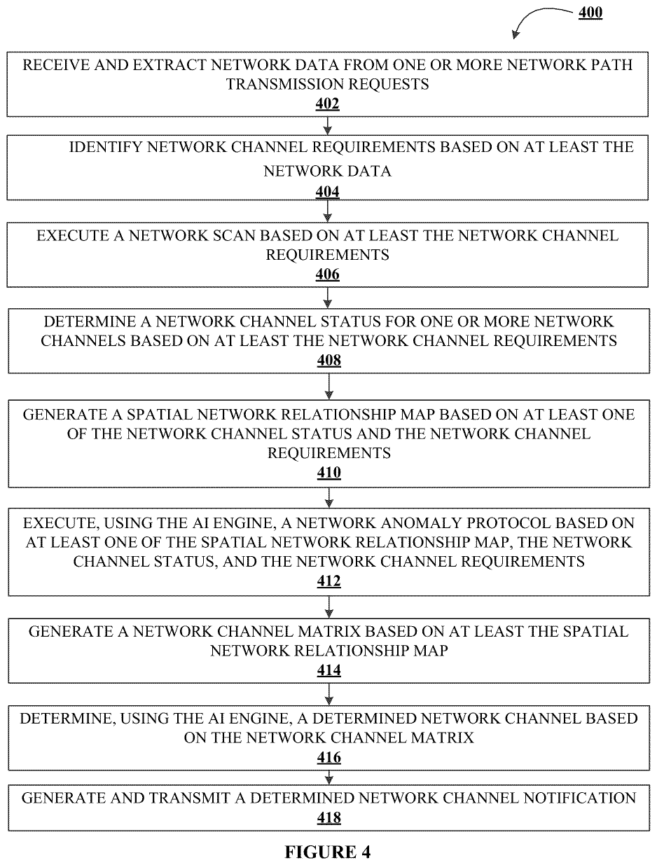

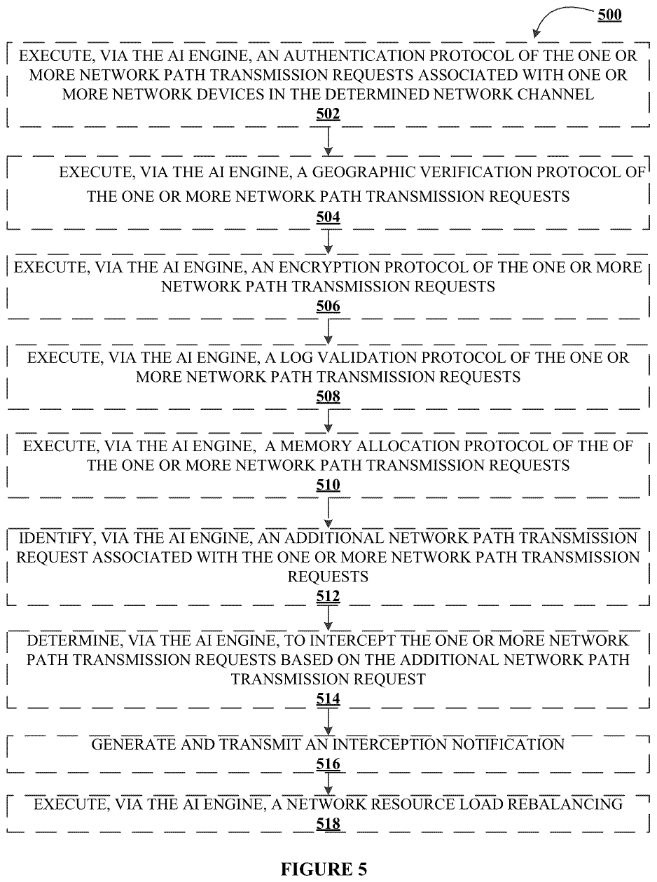

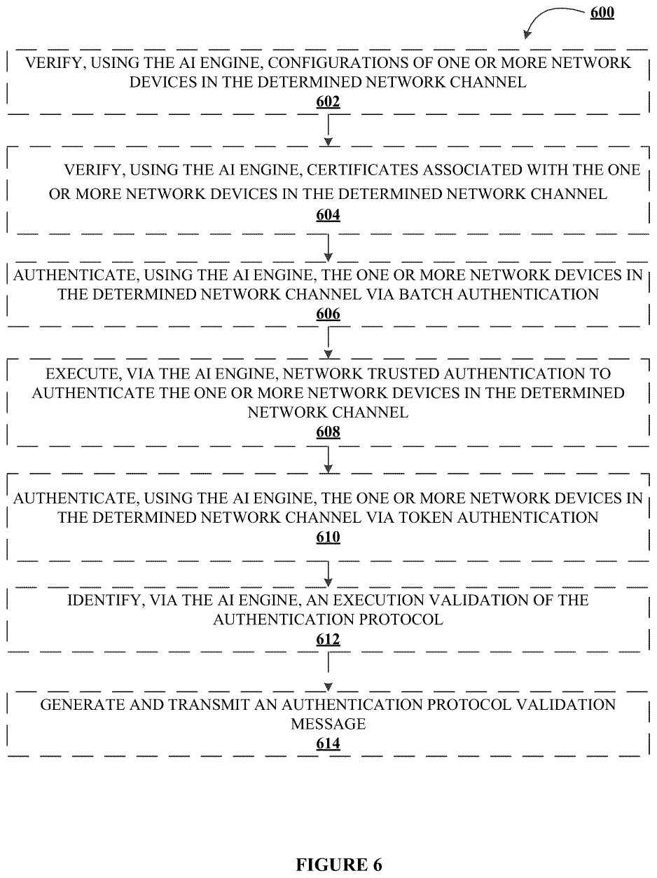

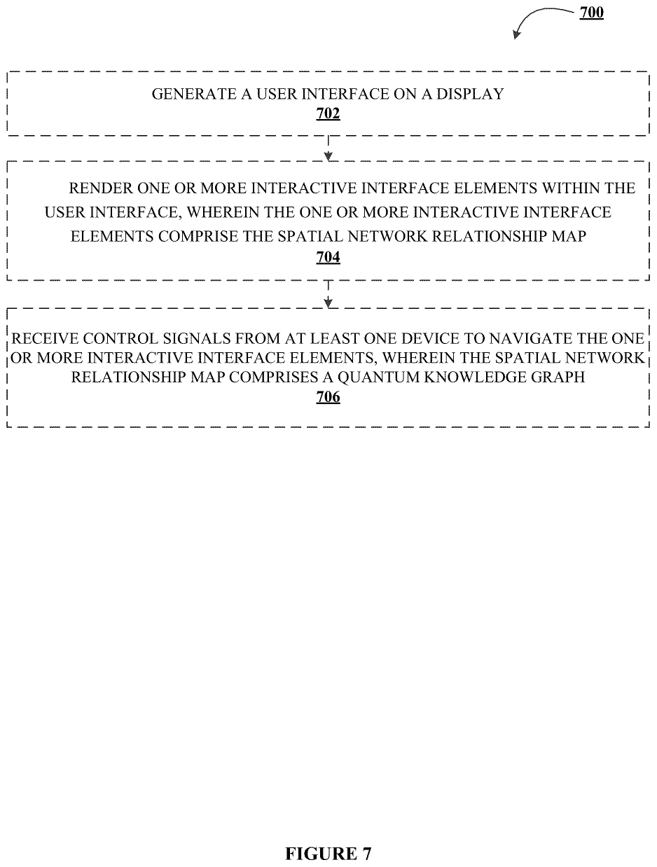

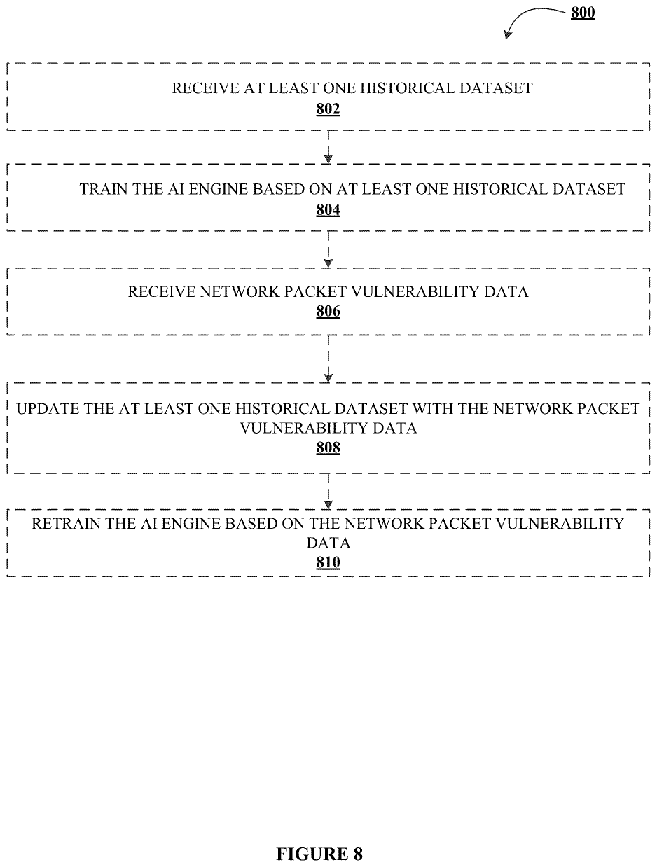

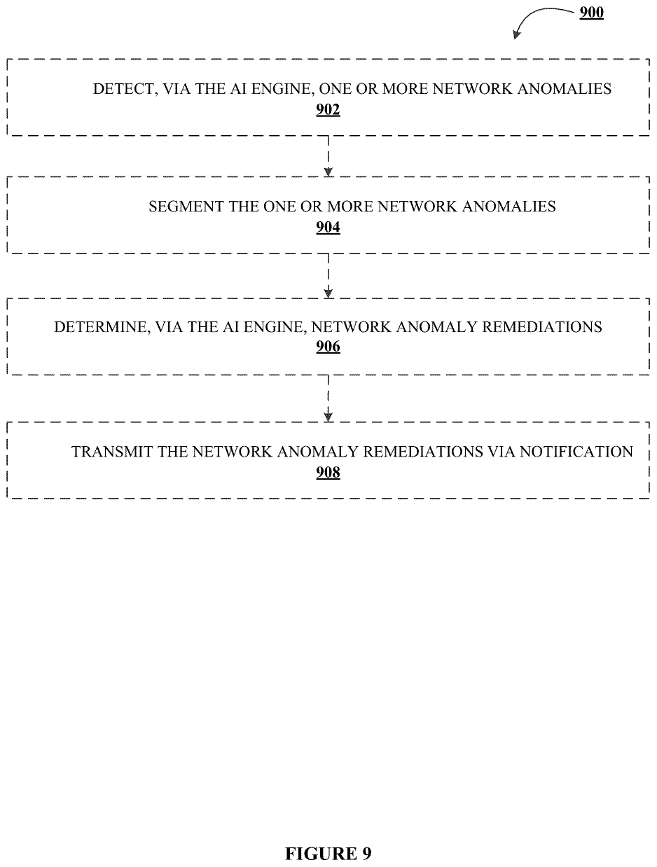

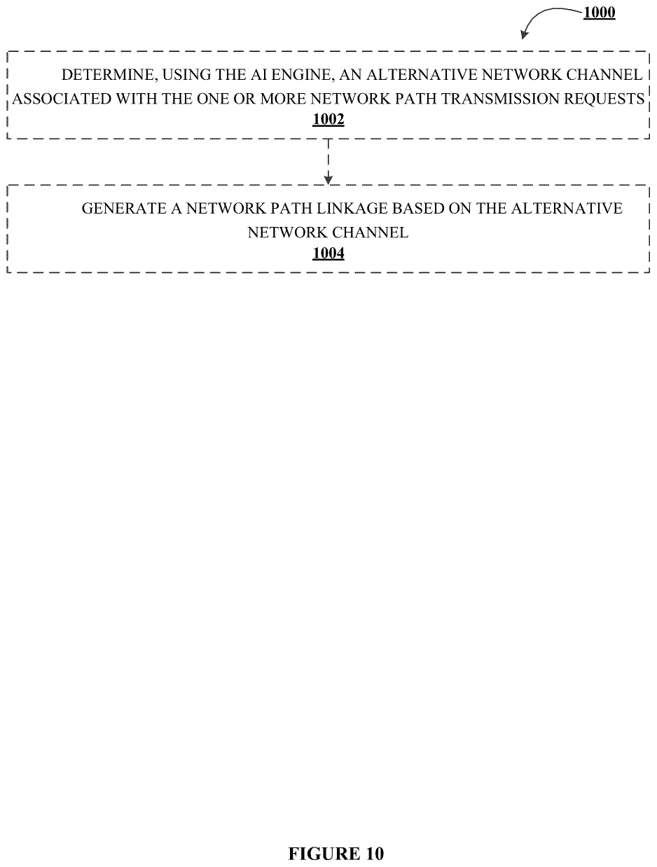

FIG. 3 illustrates an exemplary generative AI engine subsystem architecture, in accordance with an embodiment of the disclosure;

FIG. 4 illustrates a process flow for determining network paths and eliminating channel redundancy using AI and quantum knowledge graphing, in accordance with an embodiment of the disclosure;

FIG. 5 illustrates a process flow for network resource load rebalancing, in accordance with an embodiment of the disclosure;

FIG. 6 illustrates a process flow for verifying and authenticating one or more network devices, in accordance with an embodiment of the disclosure;

FIG. 7 illustrates a process flow for rendering and navigating user interface elements, in accordance with an embodiment of the disclosure;

FIG. 8 illustrates a process flow for training and retraining an AI engine, in accordance with an embodiment of the disclosure;

FIG. 9 illustrates a process flow for detecting one or more network anomalies and determining remediations, in accordance with an embodiment of the disclosure; and

FIG. 10 illustrates a process flow for determining alternative network channels, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, adding new accounts, opening new accounts, adding or modifying account parameters/restrictions, modifying a payee list associated with one or more accounts, setting up automatic payments, performing/modifying authentication procedures and/or credentials, and the like.

As described in further detail, the present disclosure provides a solution to the above-referenced problems in the by field of technology by determining network paths and eliminating channel redundancy using AI and quantum knowledge graphing based on detected network anomalies, security requirements, and network channel availability. The system utilizes artificial AI and quantum knowledge graphs to generate and evaluate spatial network relationships amongst network devices. The system identifies anomalies based on geography, network traffic behavior patterns, and audit logs. Based on anomaly detection and network path monitoring, the system generates a network channel matrix to identify relationships and dependencies amongst network devices. The network channel matrix facilitates evaluating potential network transmission paths and network channels suitable for a given network transmission.

In addition, the invention utilizes particle swarm optimization, via an AI engine, to detect suspicious actions, latency problems, and security challenges associated with a network path transmission request. By using particle swarm optimization, the invention avoids utilizing parallel channels or overloading existing channels, increasing network performance. Additionally, the invention provides dynamic workload and resource management by evaluating and verifying configurations, certificates, and authentication, ensuring security, error handling, and avoiding misappropriation actions.

What is more, the present disclosure provides a technical solution to a technical problem. As described herein, the technical problem includes determining network paths and eliminating channel redundancy using AI and quantum knowledge graphing. The technical solution presented herein allows for dynamic, intelligent, and automated network monitoring, anomaly detection, network transmission path determining, and elimination of redundant network channels. In particular, determining network paths and eliminating channel redundancy using AI and quantum knowledge graphing is an improvement over existing solutions to the technical challenges, (i) with fewer steps to achieve the solution, thus reducing the amount of computing resources, such as processing resources, storage resources, network resources, and/or the like, that are being used (e.g., eliminating redundant network path transmissions, execution network resource load rebalancing, and/or the like), (ii) providing a more accurate solution to problem, thus reducing the number of resources required to remedy any errors made due to a less accurate solution (e.g., executing an authentication protocol to validate authorized access, verifying geographic parameters, validating encryption, analyzing logs, assessing memory allocations, and/or the like), (iii) removing manual input and waste from the implementation of the solution, thus improving speed and efficiency of the process and conserving computing resources (e.g., by implementing bypasses on trusted network devices to reduce network loads), (iv) determining an optimal amount of resources that need to be used to implement the solution, thus reducing network traffic and load on existing computing resources (e.g., by identifying parallel network channels and/or by determining to intercept network path transmissions requests to mitigate redundancies). Furthermore, the technical solution described herein uses a rigorous, computerized process to perform specific tasks and/or activities that were not previously performed. In specific implementations, the technical solution bypasses a series of steps previously implemented, thus further conserving computing resources.

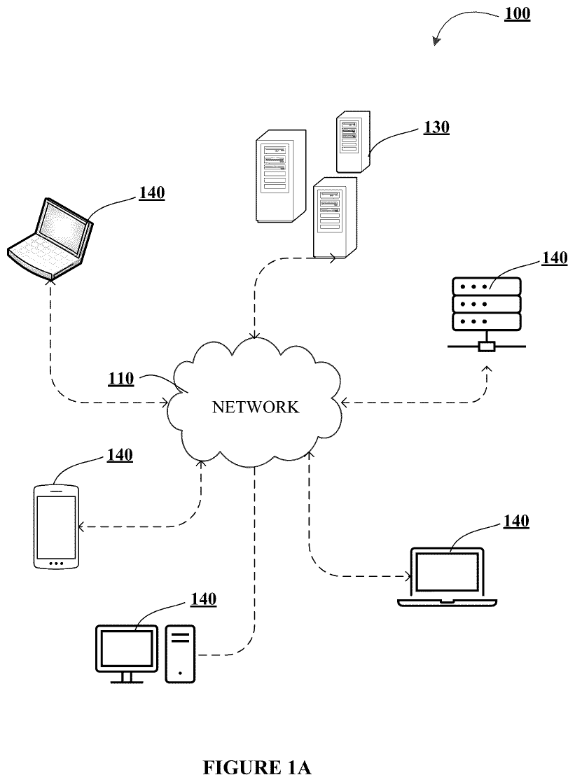

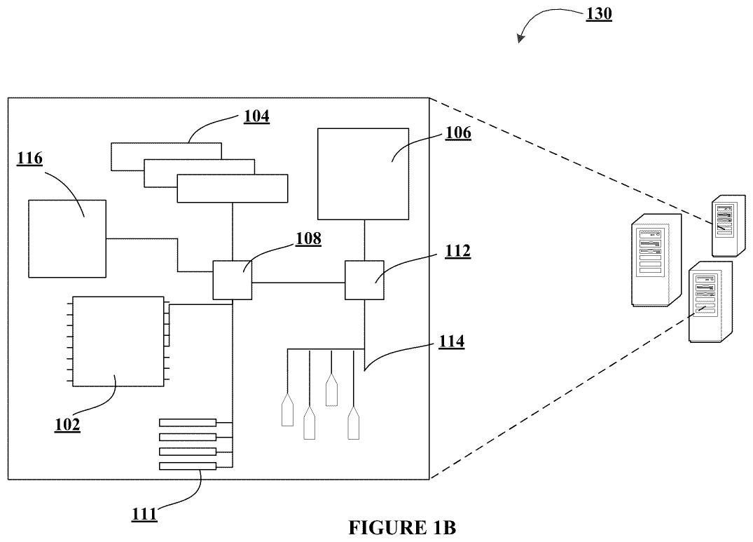

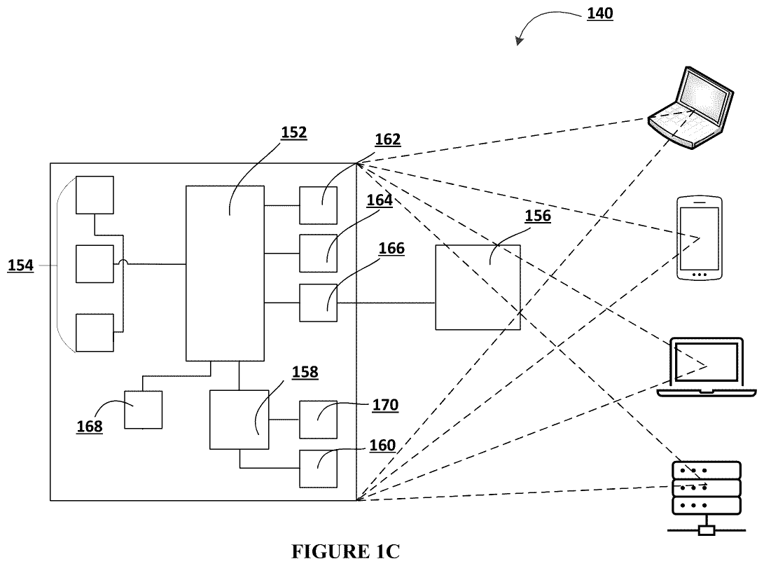

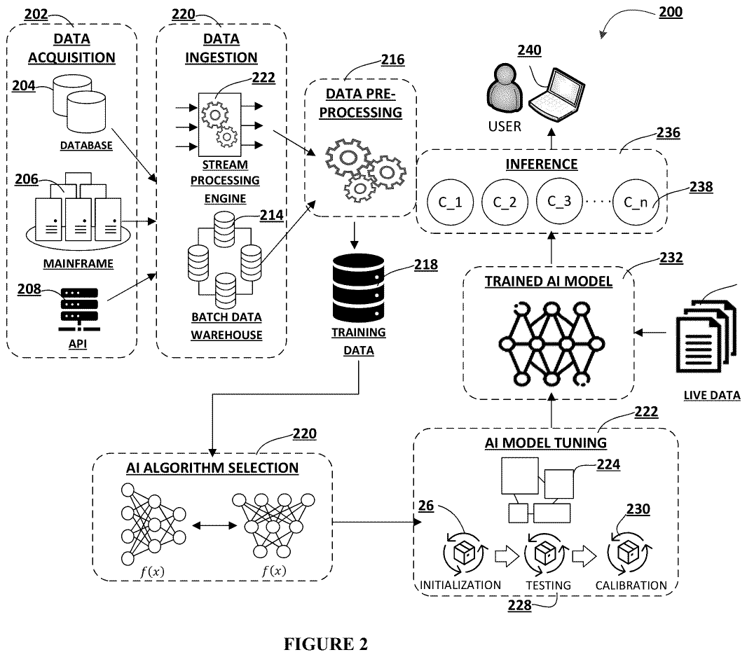

FIGS. 1A-1C illustrate technical components of an exemplary distributed computing environment for determining network paths and eliminating channel redundancy using artificial intelligence and quantum knowledge graphing 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

FIG. 2 illustrates an exemplary AI engine subsystem architecture 200, in accordance with an embodiment of the disclosure. The artificial intelligence subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including Rational Database Management Systems (RDBMs), other types of databases, Simple Storage System (S3) buckets, Comma Separated Values (CSVs), or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naëve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the Machine Learning (ML) model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a Large Language Model (LLM), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In Machine Learning (ML), the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, Bidirectional Encoder Representations from Transformers (BERT), Generative Pre-trained Transformer (GPT), or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to manage tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or Recurrent Neural Networks (RNNs) like WaveNet, designed to manage sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL (Kullback-Liebler) divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or Graphical Processing Units (GPUs), where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

FIG. 4 illustrates a process flow 400 for determining network paths and eliminating channel redundancy using AI and quantum knowledge graphing, in accordance with an embodiment of the disclosure. In some embodiments, a system (e.g., similar to one or more of the systems described herein with respect to FIGS. 1A-1C) may perform one or more of the steps of process flow 400. For example, an anomaly detection in hybrid infrastructure deployment environments system (e.g., the system 130 described herein with respect to FIGS. 1A-1C) may perform the steps of process flow 400. In some embodiments, an AI engine (e.g., such as the AI engine like that described in FIG. 2) or a generative AI subsystem (e.g., such as the generative AI subsystem described in FIG. 3) may perform some or all of the steps described in process flow 400.

As shown in block 402, the process flow 400 may include the step of receiving and extracting network data from one or more network path transmission requests. In some embodiments of the disclosure, the one or more network path transmission requests comprises a user request to access network data, network data repositories, network resource accounts, network transactions, and/or the like. According to some some embodiments, the one or more network path transmission requests may be transmitted via a communication channel, wherein the communication channel comprises encrypted transmissions, communications, data pipelines, and/or the like. In some embodiments, the one or more network path transmission requests may be transmitted via an Extract, Transform, and Load (ETL) process to receive the one or more network path transmission requests from the at least one or more data sources, process the extracted network data, and then store the extracted network data in an internal data storage repository. According to some embodiments, the network data may comprise a network file, memory location of a repository, unique identification number, network transaction metadata, and/or the like. In some embodiments, an AI engine may receive the one or more network path transmissions requests and/or extract the network data from the one or more network path transmissions requests. According to some embodiments, a network device may receive and extract network data from one or more network path transmission requests at the application layer of the network device. Upon

As shown in block 404, the process flow 400 may include the step of identifying network channel requirements based on at least the network data. According to some embodiments, the network channel requirements may comprise verification criteria for one or more network devices, network status, known network anomalies, network traffic patterns, network router validation, network switch validation, firewall validation, firewall authorization, server validation, secure network path validation, encryption criteria, data security requirements, execution speed requirements, authorization requirements, authentication methods, quality of service, network device compatibility, data redundancy requirements, access controls, scalability, and/or the like. In some embodiments, an AI engine may identify the network channel requirements. According to some embodiments, the AI engine may continuously monitor network data packets to identify the network channel requirements as network traffic evolves over time. Alternatively or additionally, the network data may comprise the network channel requirements. By way of non-limiting example, and in some embodiments, a user, connected system, network device, and/or the like may transmit network channel requirements within the one or more network path transmission requests. According to some embodiments, the network channel requirements may be based on available internal networks and/or external networks.

As shown in block 406, the process flow 400 may include the step of executing a network scan based on at least the network channel requirements. In some embodiments, the network scan may be executed by a network scanner, network performance monitor, Internet Protocol (IP) scanner, the AI engine, and/or the like. According to some embodiments, the network scan may be executed continuously, dynamically via network scan trigger, on-demand via received request, at set intervals via batch processing, and/or the like. The network scan may comprise an internal vulnerability scan, external vulnerability scan, full-assessment scan, and/or penetration test, according to some embodiments. In some embodiments, the network scan may comprise at least one subnet of one network, one or more predetermined subnets of one or more networks, and/or the like. According to some embodiments, the AI engine may log vulnerabilities, network anomalies, performance errors, latencies, and/or the like while executing the network scan. In a non-limiting example, and in some embodiments, the network scan may comprise logging each network device (e.g., router, switch, firewall, server, network pathway, and/or the like) for suspicious activities, missing software patches, and/or maintenance downtime.

As shown in block 408, the process flow 400 may include the step of determining a network channel status for one or more network channels based on at least the network channel requirements. According to some embodiments, the network channel status may comprise a determination of active status, inactive status, compromised, uncompromised, and/or the like. By way of a non-limiting example, and in some embodiments, a network channel status of active may be associated with a network channel comprising network devices that are online and presently are outside a maintenance downtime window. In some embodiments, a network channel status of inactive may be associated with a network channel that is partially or totally offline due to suspicious activity detected, at least one network device undergoing maintenance, and/or the like. According to some embodiments, an uncompromised network channel status may comprise a network channel comprising no detected anomalies, no suspicious activities, and/or the like. A compromised network status may be associated with detected anomalies, suspicious activities, and/or the like.

As shown in block 410, the process flow 400 may include the step of generating a spatial network relationship map based on at least one of the network channel status and the network channel requirements. In some embodiments, the spatial relationship network map may comprise a network topology map comprising relations between components within a network channel, dependencies amongst components in a network channel, and/or the like. The spatial relationship network map may comprise mapping server configurations and services hosted on servers within the network; firewall rules and policies to visualize network security and traffic filtering; router connections and routing information to understand network traffic flow; switch configurations and network topologies to show switch-device connectivity; Transmission Control Protocol/Internet Protocol (TCP/IP) protocols and communication between network components to analyze data exchange; and/or services deployed on network components and their dependencies to show service interactions in the network.

The spatial relationship network map may comprise mapping dependencies between network devices and network components to visualize dependencies within network infrastructure and to identify parallel network channels, according to some embodiments. By way of non-limiting example, and in some embodiments, mapping dependencies may comprise examining server connections and communication with other network components to identify dependencies; analyzing firewall rules and policies to understand network traffic flow and dependencies on permitted connections; mapping router configurations and routing tables to determine network dependencies and traffic routing paths; visualizing switch connections and network topologies to detect dependencies on devices and network segments; analyzing TCP/IP protocols and data communications between network components to highlight dependencies on data exchange; and mapping service dependencies and interactions within the network to understand service dependencies.

In some embodiments, the dependencies of network devices may comprise relational dependencies between switches, routers, firewalls, load balancers, access points, and/or gateways. According to some embodiments, dependencies of switches may comprise relational dependencies such as virtual local area networks, trunking, spanning tree protocol, port security, quality of services, and/or link aggregation. In some embodiments, the dependencies of routers may comprise relational dependencies such as routing protocols, router access control lists, network address translator routers, Dynamic Host Configuration Protocol, routing tables, and/or wide area network interfaces. According to some embodiments, dependencies of firewalls may comprise relational dependencies such as access control lists, intrusion detection systems and intrusion prevention systems, virtual private networks, stateful inspections, and/or application layer filtering. In some embodiments, the dependencies of load balancers may comprise relational dependencies such as traffic distribution, health checks, secure socket layer offloading, Layer 7 Routing, and/or session persistence. According to some embodiments, the dependencies of access points may comprise relational dependencies such as wireless access point security, Service Set Identifiers, radio bands, channel selection, and/or wireless standards. In some embodiments, the dependencies of gateways may comprise relational dependencies such as local area network-wide area network routing, network address translation, proxy server, virtual private network server, firewall, and/or Domain Name System.

As shown in block 412, the process flow 400 may include the step of executing, using the AI engine, a network anomaly protocol based on at least one of the spatial network relationship map, the network channel status, and the network channel requirements. In some embodiments, the network anomaly protocol may comprise analyzing network devices for potential anomalies and/or suspicious activities. By way of non-limiting example, and in some embodiments, the potential anomalies and/or suspicious activities may comprise abnormal spikes in network traffic, unauthorized access attempts, unfamiliar or unknown devices connected to the network, abnormal bandwidth usage associated with network devices; unexpected configuration changes, excessive broadcast/multicast traffic, unauthorized port access, MAC address spoofing associated with switches; routing table inconsistencies, unexpected route changes, high CPU/memory usage, unauthorized access attempts, routing loops associated with routers; denied traffic logs, failed login attempts, abnormal firewall rule changes, suspicious IP addresses or domains in logs associated with firewalls; sudden drops in performance, unexpected traffic patterns, secure socket layer (SSL) certificate issues, excessive number of connections to one or more virtual IP addresses (VIP) associated with load balancers; at least one failed authentication attempts, unauthorized access points detected, rogue access points, sudden and unexpected changes in wireless network settings associated with access points; and/or abnormal spikes in internet traffic, unauthorized VPN connections, malware-infected devices accessing the internet, unusual Domain Name System (DNS) queries associated with gateways.

In some embodiments, the network anomaly protocol comprises a particle swarm optimization model configured to scan audit logs, identify signatures and patterns, monitor previous network transmission requests, monitor increases and decreases in network traffic, determine irregular patterns in network packets, and determine a rules criteria threshold associated with rules data. According to some embodiments, the particle swarm optimization model may comprise randomizing particles for task allocation in network components; assessing fitness based on redundancy and efficiency factors in particles; updating personal best positions using evaluated fitness values; identifying best global fitness particle adjusting particle velocities to meet validation and redundancy needs; modifying particle positions for efficient exploration; locating redundant tasks using particle data and fitness; removing identified redundant tasks from particle allocations; evaluating particle fitness after task removals; revising personal and global best positions based on new fitness evaluations; and evaluating for termination criteria and output the optimized solution that eliminates redundant tasks in the distributed networking system while maintaining efficiency and performance.

As shown in block 414, the process flow 400 may include the step of generating a network channel matrix based on at least the spatial network relationship map. In some embodiments, the network channel matrix comprises a network channel label, network path transmission threshold, last detected anomaly timestamp, security criteria, network channel maintenance timestamp, network channel activity threshold, and network path length. According to some embodiments, the network channel matrix may comprise a scorecard to evaluate the most secure network channel for the one or more network path transmission requests. In such configurations, the network channel matrix indicates at least one network channel that meets the requisite security requirements. In some embodiments, the network channel label may be associated with a name and/or unique identifier for a network channel. The network path transmission threshold may comprise a maximum and/or minimum data transfer bandwidth threshold and/or cost associated with a certain network path transmission, in some embodiments.

According to some embodiments of the disclosure, the last detected anomaly timestamp may comprise a recorded timestamp of the most recent detected anomaly for a given network channel. The network channel matrix may further comprise an anomaly log associated with the last detected anomaly timestamp to provide data about the detected anomaly, remediation measures, similar known anomalies, emerging anomalies with similar threat characteristics, and/or the like, in some embodiments. The security criteria may comprise requirements associated with encryption, data security, authentication, validation, authentication credentials, and/or the like, in some embodiments. The network channel activity threshold may comprise a marker indicating whether a network channel is active, according to some embodiments. The network channel activity threshold may comprise a binary indicator, qualitative descriptor, and/or numerical rating, according to some embodiments. The network path length may comprise a determination that the network channel has the shortest network path, of the evaluated network paths, for executing the one or more network transmission requests, in some embodiments. According to some embodiments, the AI engine may determine the network path of each network channel of the network channel matrix. The network path length may comprise a binary indicator, qualitative descriptor, and/or numerical rating, according to some embodiments. In some embodiments, determining the shortest path length of each network channel of the network channel matrix may determine which available network channel provides the quickest execution time of a network path transmission associated with the one or more network path transmissions requests.

As shown in block 416, the process flow 400 may include the step of determining, using the AI engine, a determined network channel based on the network channel matrix. According to some embodiments, the AI engine determines the determined network channel based on analyzing network data packets. In some embodiments, the AI engine may determine the determined network channel based on logs indicating unauthorized access attempts, evaluate network traffic patterns to avoid network channels with abnormal network traffic spikes, and/or select a network channel with appropriate CPU and/or GPU usage (e.g., avoiding network channel with high volumes and/or high memory utilization). In some embodiments, the AI engine may analyze the network channel matrix to compare network channels. According to some embodiments, the AI engine may determine a predicted network transmission bandwidth requirement and evaluate which network channels have a requisite network path transmission threshold, including without limitation evaluating existing consumption of the network path transmission threshold by other processes. In some embodiments, the AI engine may evaluate the last detected anomaly timestamps of network channels to evaluate frequency and recentness of identified anomalies. By evaluating anomaly data and metadata, the AI engine ensures security of a network transmission by avoiding compromised network channels. Furthermore, in some embodiments, the AI engine may analyze security criteria (e.g., encryption, data security, authentication, validation, authentication credentials, and/or the like) to determine if a given network channel is adequately secure to process a network path transmission associated with the one or more network path transmission requests. By evaluating anomaly data and metadata and security criteria, the AI engine ensures security of a network transmission by avoiding compromised network channels and network channels that are inadequately secure. In some embodiments, a network channel may not be selected as the determined network channel because it is partially and/or completely inactive, based at least in part on the network channel activity threshold. According to some embodiments, the AI engine may determine the determined network channel by evaluating the network channel maintenance timestamp to determine if a network channel is partially and/or completely lacking requisite maintenance. The AI engine may determine and evaluate network path length of each network channel, in some embodiments, to determine potential latency and execution time issues with a given network channel. However, the AI engine may determine the determined network channel by selecting a network channel with a larger network path length if a network channel with a shorter network path length is deficient in areas (e.g., required maintenance, data security requirements, security criteria, and/or the like).

As shown in block 418, the process flow 400 may include the step of generating and transmitting a determined network channel notification. In some embodiments, the AI engine may generate and/or transmit the notification. According to some embodiments of the disclosure, the determined network channel notification may comprise the determined network channel. In some embodiments, the determined network channel notification may comprise a communication transmission, wherein the communication transmission may comprise text data, audio data, visual data, and/or the like. In some embodiments, the notification may be transmitted via an ETL process, transmitted to a network device, and/or transmitted to a user device associated with at least one network user.

FIG. 5 illustrates a process flow for network resource load rebalancing, in accordance with an embodiment of the disclosure. In some embodiments, a system (e.g., similar to one or more of the systems described herein with respect to FIGS. 1A-1C) may perform one or more of the steps of process flow 500. For example, a determining network paths and eliminating channel redundancy using AI and quantum knowledge graphing system (e.g., the system 130 described herein with respect to FIGS. 1A-1C) may perform the steps of process flow 500. In some embodiments, an AI engine (e.g., such as the AI engine like that described in FIG. 2) or a generative AI subsystem (e.g., such as the generative AI subsystem described in FIG. 3) may perform some or all of the steps described in process flow 500.

As shown in block 502, the process flow 500 may include the step of executing, via the AI engine, an authentication protocol of the one or more network path transmission requests associated with one or more network devices in the determined network channel. In some embodiments, the authentication protocol may comprise authenticating the one or more network devices. According to some embodiments, the authentication protocol may comprise authenticating the one or more network path transmission requests by transmitting a message to the source of the one or more network path transmission requests to confirm authenticity. According to some embodiments, the AI engine may utilize authentication methods (multi-factor, one-time password, authentication credentials, token, batch, and/or the like) to execute the authentication protocol. According to some embodiments, the authentication protocol may comprise determining that the one or more network devices have previously been authenticated and implementing a bypass, wherein the bypass does not require re-authentication. By bypassing previously authenticated network devices, the system preserves network resources, network channel bandwidth, and reduces latencies associated with network path transmissions. In some embodiments, the AI engine may determine the geographic verification protocol failed and may log a failure of the authentication protocol, including without limitation transmitting an alert comprising the log and/or metadata associated with the authentication protocol. According to some embodiments, the AI engine may initiate a loop to re-attempt the authentication protocol.

As shown in block 504, the process flow 500 may include the step of executing, via the AI engine, a geographic verification protocol of the one or more network path transmission requests. According to some embodiments, the geographic verification protocol may comprise determining that the one or more network devices have previously been verified and implementing a bypass, wherein the bypass does not require re-executing geographic verification. By bypassing previously geographically verified network devices, the system preserves network resources, network channel bandwidth, and reduces latencies associated with network path transmissions. According to some embodiments, the geographic verification protocol may comprise comparing a geographic stamp of the location of the source of the one or more network path transmission requests to a geographic repository to confirm the geographic location is permissible. According to some embodiments, the AI engine may determine a location of the IP address associated with the network device that transmitted the one or more network path transmission requests to determine if the IP address is banned, if the location is outside a permissible geographic region, and/or the like. In some embodiments, the AI engine may determine the geographic verification protocol failed and may log a failure of the geographic verification protocol, including without limitation transmitting a geographic verification protocol alert. According to some embodiments, the AI engine may initiate a loop to re-attempt the geographic verification protocol.

As shown in block 506, the process flow 500 may include the step of executing, via the AI engine, an encryption protocol of the one or more network path transmission requests. According to some embodiments, the encryption protocol may comprise determining that the one or more network devices have previously successfully had encryption protocol verified and implementing a bypass, wherein the bypass does not require re-executing encryption protocol. By bypassing previously verified network devices, the system preserves network resources, network channel bandwidth, and reduces latencies associated with network path transmissions. According to some embodiments, the encryption protocol may comprise code signing and encrypting the network data in the one or more network path transmission requests. In some embodiments, encryption protocol may comprise decrypting, data extraction, data analysis, and/or re-encrypting the network data in the one or more network path transmission requests. In some embodiments, the encryption protocol may comprise asymmetric encryption, symmetric encryption, end-to-end encryption, and/or hashing. In some embodiments, the AI engine may determine the encryption protocol failed and may log a failure of the encryption protocol, including without limitation transmitting a failed encryption protocol alert. According to some embodiments, the AI engine may initiate a loop to re-attempt the encryption protocol.

As shown in block 508, the process flow 500 may include the step of executing, via the AI engine, a log validation protocol of the one or more network path transmission requests. According to some embodiments, the log validation protocol may comprise determining that the one or more network devices have previously successfully had log validation protocol verified and implementing a bypass, wherein the bypass does not require re-executing log validation protocol. By bypassing previously verified network devices, the system preserves network resources, network channel bandwidth, and reduces latencies associated with network path transmissions. In some embodiments, the log validation protocol may comprise evaluating audit logs compiled previously and/or compiling audit logs and evaluating the audit logs dynamically. In some embodiments, the AI engine may compile the logs for the log validation protocol continuously, dynamically upon trigger, at set intervals, and/or the like. In some embodiments, the AI engine may determine the log validation protocol failed and may log a failure of the log validation protocol, including without limitation transmitting a log validation protocol alert. According to some embodiments, the AI engine may initiate a loop to re-attempt the log validation protocol.

As shown in block 510, the process flow 500 may include the step of executing, via the AI engine, a memory allocation protocol of the of the one or more network path transmission requests. According to some embodiments, the memory allocation protocol may comprise determining that the one or more network devices have previously successfully had memory allocation protocol verified and implementing a bypass, wherein the bypass does not require re-executing log memory allocation protocol. By bypassing previously verified network devices, the system preserves network resources, network channel bandwidth, and reduces latencies associated with network path transmissions. In some embodiments, the AI engine may determine the memory allocation protocol failed and may log a failure of the memory allocation protocol, including without limitation transmitting a memory allocation protocol alert. According to some embodiments, the AI engine may initiate a loop to re-attempt the memory allocation protocol. In some embodiments, the memory allocation protocol may comprise the AI engine identifying that a particular memory allocation within the network channel and/or network path is already allocated, and the AI engine may reassign a new memory allocation for executing the network path transmission. According to some embodiments, the memory allocation protocol may comprise clearing cache memory and/or historical memory associated with the one or more network path transmission requests, historical network path transmissions requests, network path transmissions, and/or the like.

As shown in block 512, the process flow 500 may include the step of identifying, via the AI engine, an additional network path transmission request associated with the one or more network path transmission requests. According to some embodiments, the AI engine may use a particle swarm optimization model for identifying the additional network path transmission request associated with the one or more network path transmission requests. In some embodiments, the AI engine may determine that network data from the additional network path transmission request is equivalent to the network data in the one or more network path transmission requests. The AI engine may make identifications dynamically, via a real-time trigger (e.g., receipt of one or more network path transmission requests), and/or via predetermined intervals, according to some embodiments.

According to some embodiments, the AI engine may make an identification when the additional network path transmission request comprises inspecting data packets from trusted internal networks; logging network traffic from trusted sources (as opposed to logging traffic from unauthorized sources); encrypting traffic that already has been encrypting; tunneling all network traffic through a virtual private network server; executing multiple instances of at least one service on two or more nodes; transmitting identical data via two or more nodes to the same network location; processing the same data across multiple nodes in a distributed system; duplicate user authentication for service validation; redundant authentication mechanisms for firewall authentication; utilizing multiple methods for access permission verification for router access checks; validating port access control on multiple levels to validate switch port access; utilizing redundant methodology for validating configuration revisions of switches; using redundant configuration and monitoring of TCP/IP settings; executing multiple security scans on network services; verifying secure socket layer certificates of load balancers using redundant methods; utilizing multiple audit logs for monitoring; implementing redundant error handling mechanisms for network component validation; implementing redundant memory allocation processes; execute memory cache cleaning and history cleaning via redundant methods; and/or conducting multiple secure scans on systems resources for monitoring.

As shown in block 514, the process flow 500 may include the step of determining, via the AI engine, to intercept the one or more network path transmission requests based on the additional network path transmission request. According to some embodiments, the AI engine may initiate an interception, freeze, hold, and/or the like of the additional network path transmission request based on the determination that the network data is equivalent in the additional network path transmission request and the one or more network path transmission requests to preserve network resources, network channel bandwidth, and reduces latencies associated with network path transmissions. Allocating the same memory, bandwidth, and/or computing resources to processing and transmitting the same network data can result in performance issues, latencies, delays, overallocated memory and/or CPU, and/or the like. The AI engine may make determinations dynamically, via a real-time trigger (e.g., receipt of a network path transmissions request), and/or via predetermined intervals, according to some embodiments. In some embodiments, intercepting the one or more network path transmission requests may comprise canceling the one or more network path transmission requests and transmitting a cancelation alert to one or more network devices and/or at least one user device.

As shown in block 516, the process flow 500 may include the step of generating and transmitting an interception notification. In some embodiments, the AI engine may generate and/or transmit the interception notification. According to some embodiments of the disclosure, the interception notification may comprise the intercepted one or more network path transmissions requests, log associated with the intercepted one or more network path transmissions requests, logic for the interception, timestamp of the interception, network data, and/or the like. In some embodiments, the interception notification may comprise a communication transmission, wherein the communication transmission may comprise text data, audio data, visual data, and/or the like. In some embodiments, the interception notification may be transmitted via an ETL process, transmitted to a network device, and/or transmitted to a user device associated with at least one network user.

As shown in block 518, the process flow 500 may include the step of executing, via the AI engine, a network resource load rebalancing. In some embodiments, the AI engine may comprise a generative AI model, wherein the generative AI model generates network resource load rebalancing recommendations. In some embodiments, the generative AI model may comprise an LLM, VAE, autoregressive model, RNN, transformer-based model, and/or the like. According to some embodiments, the communication channel may comprise encrypted transmissions, communications, and/or the like.

According to some embodiments, the network resource load rebalancing recommendations may be generated by the AI engine, via network operator, and/or via input from internal and external operators. The network resource load rebalancing may comprise determining to cancel paused network path transmissions requests, reallocate network path transmissions requests to different network resource channels, and/or reactivate paused network path transmissions requests, according to some embodiments. In some embodiments, the network resource load rebalancing may comprise a feedback loop wherein the AI engine is trained on canceled, paused, and/or reactivated network path transmissions requests to refine the AI engine. According to some embodiments, the network resource load rebalancing may comprise generating alerts comprising executed network resource path transmission requests, paused network resource path transmission requests, canceled network resource path transmission requests, and/or reactivated network resource path transmission requests to generate model feedback to further train the AI engine.

FIG. 6 illustrates a process flow for verifying and authenticating one or more network devices, in accordance with an embodiment of the disclosure. In some embodiments, a system (e.g., similar to one or more of the systems described herein with respect to FIGS. 1A-1C) may perform one or more of the steps of process flow 600. For example, a determining network paths and eliminating channel redundancy using AI and quantum knowledge graphing system (e.g., the system 130 described herein with respect to FIGS. 1A-1C) may perform the steps of process flow 600. In some embodiments, an AI engine (e.g., such as the AI engine like that described in FIG. 2) or a generative AI subsystem (e.g., such as the generative AI subsystem described in FIG. 3) may perform some or all of the steps described in process flow 600.

As shown in block 602, the process flow 600 may include the step of verifying, using the AI engine, configurations of one or more network devices in the determined network channel. According to some embodiments, the verifying configurations of the one or more network devices may comprise identifying network requirements, evaluating specifications of the one or more network devices, testing functionality, reviewing configurations, and/or documenting analytics associated with the one or more network devices. In some embodiments, verifying configurations may comprise validating the IP address, access controls, network channel and band, gateway, log settings, and/or the like. In some embodiments, the AI engine may determine the network topology (e.g., bus, ring, star, mesh, spine-leaf, and/or hybrid) of the network associated with the one or more network devices and determine configurations comply with the network topology. The AI engine may verify configurations via real-time trigger, continuously, and/or at predetermined intervals, according to some embodiments.

As shown in block 604, the process flow 600 may include the step of verifying, using the AI engine, certificates associated with the one or more network devices in the determined network channel. In some embodiments, verifying the certificates associated with the one or more network devices may comprise tracking and monitoring logs associated with certificates issued by various Certificate Authorities, wherein the tracking and monitoring may comprise detecting anomalies in certificates. According to some embodiments verifying certificates may comprise utilizing a public key retrieved from a trust repository to verify a certificate, wherein the verification comprises validating a digital signature, time interval validity, and the issuing domain of the certificate. In some embodiments, verifying certificates may comprise mutual transport layer security. The AI engine may verify certificates via real-time trigger, continuously, and/or at predetermined intervals, according to some embodiments.

As shown in block 606, the process flow 600 may include the step of authenticating, using the AI engine, the one or more network devices in the determined network channel via batch authentication. According to some embodiments, the batch authentication may comprise simultaneously authenticating the one or more network devices concurrently. In some embodiments, the AI engine may receive authentication requests from the one or more network devices and execute the authentication during a single operation execution. In some embodiments, the AI engine may utilize hashing to verify the one or more network devices utilizing a shared trust validation indicator and/or challenge-response authentication action.

As shown in block 608, the process flow 600 may include the step of executing, via the AI engine, network trusted authentication to authenticate the one or more network devices in the determined network channel. In some embodiments, the network trusted authentication may comprise multifactor authentication, wherein the multifactor authentication comprises at least two of a one-time password, a physical attribute authentication, authentication application, and authentication credentials. According to some embodiments, the AI engine may validate that the one or more network devices have already been authenticated by an additional network device, service, and/or system within the same internal network and thus remain authenticated.

As shown in block 610, the process flow 600 may include the step of authenticating, using the AI engine, the one or more network devices in the determined network channel via token authentication. In some embodiments, the AI engine may utilize JSON (JavaScript Object Notation) web tokens (JWT) (e.g., encoded JSON comprising claims and a signature) to authenticate the one or more network devices in the determined network channel via token authentication. According to some embodiments, the AI engine may authenticate the one or more network devices via open authorization, wherein open authorization comprises a temporary access token for limited duration.

As shown in block 612, the process flow 600 may include the step of identifying, via the AI engine, an execution validation of the authentication protocol. The execution validation may comprise confirming success and/or failure (in whole or in part) of the authentication protocol; verification of the configurations of the one or more network devices; verification of the certificates associated with the one or more network devices; authentication of the one or more network devices via batch authentication, network trusted authentication, and/or token authentication; and/or the like, according to some embodiments. In some embodiments, the execution validation of the authentication protocol may be completed in series or parallel. The execution validation may occur dynamically, via real-time trigger, or via batch processing at predetermined intervals, according to some embodiments.

As shown in block 614, the process flow 600 may include the step of generating and transmitting an authentication protocol validation message. In some embodiments, the AI engine may generate and/or transmit the authentication protocol validation message. According to some embodiments of the disclosure, the authentication protocol validation message may comprise a timestamp, network data, one or more network path transmissions, an identifier of the one or more network devices, logs associated with the authentication protocol, logs associated with the one or more network devices, and/or the like. In some embodiments, the authentication protocol validation message may comprise a communication transmission, wherein the communication transmission may comprise text data, audio data, visual data, and/or the like. In some embodiments, the authentication protocol validation message notification may be transmitted via an ETL process, transmitted to a network device, and/or transmitted to a user device associated with at least one network user.

FIG. 7 illustrates a process flow for rendering and navigating user interface elements, in accordance with an embodiment of the disclosure. In some embodiments, a system (e.g., similar to one or more of the systems described herein with respect to FIGS. 1A-1C) may perform one or more of the steps of process flow 700. For example, a determining network paths and eliminating channel redundancy using AI and quantum knowledge graphing system (e.g., the system 130 described herein with respect to FIGS. 1A-1C) may perform the steps of process flow 700. In some embodiments, an AI engine (e.g., such as the AI engine like that described in FIG. 2) or a generative AI subsystem (e.g., such as the generative AI subsystem described in FIG. 3) may perform some or all of the steps described in process flow 700.

As shown in block 702, the process flow 700 may include the step of generating a user interface on a display. According to some embodiments, the user interface may be disposed within a display device, mixed reality headset, projector system, mobile device, glasses, and/or the like. The user interface may comprise input devices and output devices, including without limitation physical buttons, capacitive touch buttons, digital icons and buttons, audio transmitter, audio receiver, microphone, speaker, and/or headphones, according to some embodiments.

As shown in block 704, the process flow 700 may include the step of rendering one or more interactive interface elements within the user interface, wherein the one or more interactive interface elements comprise the spatial network relationship map. According to some embodiments, the one or more interactive interface elements may comprise menus, channels associated with the determined network channel, icons, digital buttons, dashboards associated with the network channel matrix, graphs associated with the spatial network relationship map, digital objects, and/or the like. The one or more interactive elements may activate upon selection, interaction, and/or input from the user, according to some embodiments.

As shown in block 706, the process flow 700 may include the step of receiving control signals from at least one device to navigate the one or more interactive interface elements, wherein the spatial network relationship map comprises a quantum knowledge graph. In some embodiments, the quantum knowledge graph may comprise a network graph comprising nodes associated with network devices and edges representing relationships and/or dependencies between the network devices. In some embodiments, the quantum knowledge graph may be modeled by quantum singular value decomposition and projection.

According to some embodiments, the control signals may be associated with input devices, mobile device, one or more network devices, the interactive interface elements, microphone, audio transmitter, and/or the like. By way of non-limiting example, and in some embodiments, a user may interact with the one or more interactive interface elements, which may generate control signals. According to some embodiments, the control signals may be associated with the network data, one or more network path transmission requests, additional network path transmission requests, network channel requirements, spatial network relationship map, network channel status, network channel matrix, determined network channel, determined network channel notification, authentication protocol, geographic verification protocol, encryption protocol, log validation protocol, memory allocation protocol, additional network path transmission request, interception notification, network resource load rebalancing, configurations, certifications, authentication methods (e.g., batch, network trusted, multifactor, token, and/or the like), execution validation, authentication protocol validation message, execution validation, network path linkage, alternative network channel, and/or the like.

FIG. 8 illustrates a process flow for training and retraining an AI engine, in accordance with an embodiment of the disclosure. In some embodiments, a system (e.g., similar to one or more of the systems described herein with respect to FIGS. 1A-1C) may perform one or more of the steps of process flow 800. For example, a determining network paths and eliminating channel redundancy using AI and quantum knowledge graphing system (e.g., the system 130 described herein with respect to FIGS. 1A-1C) may perform the steps of process flow 800. In some embodiments, an AI engine (e.g., such as the AI engine like that described in FIG. 2) or a generative AI subsystem (e.g., such as the generative AI subsystem described in FIG. 3) may perform some or all of the steps described in process flow 800.

As shown in block 802, the process flow 800 may include the step of receiving at least one historical dataset. The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the AI engine may be trained. In some embodiments, the system may receive the at least one historical dataset continuously, at set internals, and/or via on-demand request generated by the AI engine, a user, an AI engine training controller, network device, and/or the like. In some embodiments, the system may receive the entire at least one historical dataset. According to sone embodiments, the system may only receive a subset of data contained within the at least one historical dataset based on training requirements associated with an AI engine training request generated by the system, user, network device, and/or the like. By training the AI engine on only a subset of the at least one historical dataset based on the most material and/or relevant data, the system may conserve computing resources, minimize energy expenditures, and/or enhance the AI engine performance. In some embodiments, the subset of data may not comprise sensitive data, preventing the inclusion of sensitive data in training the AI engine, which enhances data security and privacy.

As shown in block 804, the process flow 800 may include the step of training the AI engine based on the at least one historical dataset. In some embodiments, the at least one historical dataset comprises historical network data, historical one or more network path transmission requests, historical additional network path transmission requests, historical network channel requirements, historical spatial network relationship maps, historical network channel statuses, historical network channel matrices, historical determined network channels, historical determined network channel notifications, historical authentication protocols, historical geographic verification protocols, historical encryption protocols, historical log validation protocols, historical memory allocation protocols, historical additional network path transmission requests, historical interception notifications, historical network resource load rebalancing, historical configurations, historical certifications, historical authentication methods (e.g., batch, network trusted, multifactor, token, and/or the like), historical execution validations, historical authentication protocol validation messages, historical execution validations, historical network path linkages, historical alternative network channel, historical control signals, and/or the like. In some embodiments the AI engine may comprise a generative AI model, in which training the generative AI model may comprise ingesting the historical dataset, adjusting parameters in response to generative AI model output, evaluating the model for fine-tuning, and/or deploying the generative AI model.

As shown in block 806, the process flow 800 may include the step of receiving network packet vulnerability data. In some embodiments, receiving the network packet vulnerability data may comprise receiving network data packets comprising the network packet vulnerability data. In some embodiments, a data aggregator may collect network packet vulnerability data to generate aggregated network packet vulnerability data and transmit the aggregated network packet vulnerability data via network data packets to the system and/or AI engine. In some embodiments, the data aggregator may pre-process the network packet vulnerability data, such as data cleansing, encrypting, and/or executing an ETL process. In some embodiments, the system may process the received network data packets, such as executing decryption, data extraction, and/or the like.

As shown in block 808, the process flow 800 may include the step of updating the at least one historical dataset with the network packet vulnerability data. In some embodiments, the network packet vulnerability data may be attached to the at least one historical dataset. In such a configuration, an ETL process may be executed to transmit the network packet vulnerability data dataset to the same data storage repository as the at least one historical dataset.

As shown in block 810, the process flow 800 may include the step of retraining the AI engine based on the network packet vulnerability data. The retraining step may be executed via feedback loop for continuous retraining and/or the retraining may occur via internal-based batch jobs, according to some embodiments. In some embodiments, the AI engine may refine itself by revising its weights and other such decision factors to improve accuracy, speed, and minimize errors, based on AI engine training confidence threshold. In some embodiments, the system may determine the AI engine training confidence threshold, and if the AI engine training confidence threshold is below a given confidence threshold (e.g., predetermined, determined via notification from a network device, and/or dynamically determined by the system), the system may trigger retraining of the AI engine. In some embodiments, if criteria (e.g., network channel requirements, detected anomalies, known anomalies, network traffic criteria, user requests, emerging anomalies, forecast anomalies, one or more network path transmission requests, network channel matrix, and/or the like) and/or network packet vulnerability data are generated and/or received by the system and/or AI engine (hereinafter referred to as “new training factors”), then the system and/or AI engine may trigger in real-time retraining of the AI engine based on the new training factors. By constantly monitoring for new training factors and triggering a responsive real-time retraining, the system provides a technical solution to the challenge of monitoring new training factors and changing network traffic conditions and adjusting the system dynamically.

FIG. 9 illustrates a process flow for detecting one or more network anomalies and determining remediations, in accordance with an embodiment of the disclosure. In some embodiments, a system (e.g., similar to one or more of the systems described herein with respect to FIGS. 1A-1C) may perform one or more of the steps of process flow 900. For example, a determining network paths and eliminating channel redundancy using AI and quantum knowledge graphing system (e.g., the system 130 described herein with respect to FIGS. 1A-1C) may perform the steps of process flow 900. In some embodiments, an AI engine (e.g., such as the AI engine like that described in FIG. 2) or a generative AI subsystem (e.g., such as the generative AI subsystem described in FIG. 3) may perform some or all of the steps described in process flow 900.

As shown in block 902, the process flow 900 may include the step of detecting, via the AI engine, one or more network anomalies. The AI engine may analyze the network data to determine abnormal patterns in network communications, including without limitation mobile device-to-cloud, cloud-to-cloud, cloud-to-on-premises, network device-to-network device, client-to-server (and vice versa), network-to-network, and/or the like, according to some embodiments. In some embodiments, the AI engine may detect one or more network anomalies associated with abnormal traffic patterns (e.g., spikes from specific IP addresses, deviations from known traffic patterns associated with a network device, device associated with a network resource account, traffic from IP address in abnormal geographic location, and/or the like) associated with malicious attacks and/or unauthorized access attempts. In some embodiments, the AI engine may comprise a machine learning algorithm to learn regular traffic behavior over time periods. By way of non-limiting example, and in some embodiments, the AI engine may detect deviations in traffic behavior, execute behavioral analyses, and determine deviations in traffic behavior that signal an intrusion by an unauthorized actor and/or a misconfiguration in infrastructure, software, software services, and/or the like (e.g., one or more network anomalies).

As shown in block 904, the process flow 900 may include the step of segmenting the one or more network anomalies. In some embodiments, segmenting the one or more network anomalies may comprise generating subnets to restrict network traffic flow from specific IP addresses, network devices, and/or the like. According to some embodiments, the segmentation may comprise shutting down one or more network ports, shutting down the network in which the one or more network anomalies were detected, shutting down the network gateway, redirecting traffic through a specified port and/or gateway and/or subnet.

As shown in block 906, the process flow 900 may include the step of determining, via the AI engine, network anomaly remediations. The network anomaly remediations may comprise mitigating corrective responsive actions to remediate threats associated with the one or more network anomalies. Corrective responsive actions may comprise determining at least one alternative network channel and/or switching traffic flow to the at least one alternative network channel, shutting down the determined network channel, shutting down the network gateway, restricting intra-network and/or inter-network transmissions, partitioning at least one network into subnets for revising network traffic flow, shutting down network ports, opening additional network ports, requiring re-authenticating and re-authorizing access of a user and/or network device, revoking authorization, revoking access, implementing additional authorization and/or authentication requirements (e.g., multifactor authentication), and/or the like.

As shown in block 908, the process flow 900 may include the step of transmitting the network anomaly remediations via notification. In some embodiments, the AI engine may generate and/or transmit the notification. In some embodiments, the notification may comprise transmitting network data packets, text message, email, instant message, audio transmissions, video transmissions, alert via user interface, and/or push notification to a mobile device. According to some embodiments, the notification may be transmitted via communication, channel may comprise end-to-end encryption, a secure socket layer, transport layer security, and/or the like. By way of non-limiting example, and in some configurations, the network anomaly remediations may be transmitted via the communication channel and displayed upon a user interface. The user interface may comprise a display comprising menus with the various network anomaly remediations. A user may select one or more network anomaly remediations utilizing input devices, a mixed reality application, buttons corresponding to network event remediations, voice communications, and/or text messages, according to some embodiments. According to some embodiments, the network anomaly remediations displayed on the user interface may comprise control buttons, wherein the control buttons (e.g., approve, reject, modify, and/or the like), upon selection, may comprise determined network anomaly remediations.

FIG. 10 illustrates a process flow for determining alternative network channels, in accordance with an embodiment of the disclosure. In some embodiments, a system (e.g., similar to one or more of the systems described herein with respect to FIGS. 1A-1C) may perform one or more of the steps of process flow 1000. For example, a determining network paths and eliminating channel redundancy using AI and quantum knowledge graphing system (e.g., the system 130 described herein with respect to FIGS. 1A-1C) may perform the steps of process flow 1000. In some embodiments, an AI engine (e.g., such as the AI engine like that described in FIG. 2) or a generative AI subsystem (e.g., such as the generative AI subsystem described in FIG. 3) may perform some or all of the steps described in process flow 1000.

As shown in block 1002, the process flow 1000 may include the step of determining, using the AI engine, an alternative network channel associated with the one or more network path transmission requests. According to some embodiments, the AI engine may determine an alternative network channel by evaluating the network channel requirements, network channel matrix, data security requirements, and/or the like. The alternative network channel may comprise equivalent and/or similar network path transmission threshold, last detected anomaly timestamp, security criteria, network channel maintenance timestamp, network channel activity threshold, and network path length as the network channel, according to some embodiments. In some embodiments, the alternative network channel may facilitate network traffic flow to execute the one or more network path transmission requests. By determining the alternative network channel, the system maintains the security requirements associated with the one or more network path transmission requests to ensure security of network path transmissions, consistent execution time of network path transmissions, and neutralize impacts of detected anomalies.

As shown in block 1004, the process flow 1000 may include the step of generating a network path linkage based on the alternative network channel. In some embodiments, generating the network path linkage may comprise a two-way network request transmitted between at least two network devices and/or components, authenticating at least one of the at least two network devices and/or components, and/or transmitting a test message to confirm the success of the initiation, according to some embodiments. According to some embodiments, the network path linkage may comprise a communication pathway, a secure socket layer, transport layer security, and/or the like. According to some embodiments, the network path linkage may provide analytics, logging, monitoring, and/or network application management functionality. In some embodiments, the network path linkage may facilitate network path transmissions to execute the one or more network path transmissions requests.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining network paths and eliminating channel redundancy using artificial intelligence (AI) and quantum knowledge graphing, the system comprising:
a memory device with computer-readable program code stored thereon;
at least one processing device, wherein executing the computer-readable program code is configured to cause the at least one processing device to execute the computer-readable program code to:
receive and extract network data from one or more network path transmission requests;
identify network channel requirements based on at least the network data;
execute a network scan based on at least the network channel requirements;
determine a network channel status for one or more network channels based on at least the network channel requirements;
generate a spatial network relationship map based on at least one of the network channel status and the network channel requirements;
execute, using an AI engine, a network anomaly protocol based on at least one of the spatial network relationship map, the network channel status, and the network channel requirements;
generate a network channel matrix based on at least the spatial network relationship map;
determine, using the AI engine, a determined network channel based on the network channel matrix; and
generate and transmit a determined network channel notification.

2. The system of claim 1, wherein executing the computer-readable program code is further configured to cause the at least one processing device to:
execute, via the AI engine, an authentication protocol of the one or more network path transmission requests associated with one or more network devices in the determined network channel;
execute, via the AI engine, a geographic verification protocol of the one or more network path transmission requests;
execute, via the AI engine, an encryption protocol of the one or more network path transmission requests;
execute, via the AI engine, a log validation protocol of the one or more network path transmission requests;
execute, via the AI engine, a memory allocation protocol of the of the one or more network path transmission requests;
identify, via the AI engine, an additional network path transmission request associated with the one or more network path transmission requests;
determine, via the AI engine, to intercept the one or more network path transmission requests based on the additional network path transmission request;
generate and transmit an interception notification; and
execute, via the AI engine, a network resource load rebalancing.

3. The system of claim 2, wherein the authentication protocol further comprises:
verify, using the AI engine, configurations of one or more network devices in the determined network channel;
verify, using the AI engine, certificates associated with the one or more network devices in the determined network channel;
authenticate, using the AI engine, the one or more network devices in the determined network channel via batch authentication;
execute, via the AI engine, network trusted authentication to authenticate the one or more network devices in the determined network channel;
authenticate, using the AI engine, the one or more network devices in the determined network channel via token authentication;
identify, via the AI engine, an execution validation of the authentication protocol; and
generate and transmit an authentication protocol validation message.

4. The system of claim 1, wherein executing the computer-readable program code is further configured to cause the at least one processing device to:
generate a user interface on a display;
render one or more interactive interface elements within the user interface, wherein the one or more interactive interface elements comprise the spatial network relationship map; and
receive control signals from at least one device to navigate the one or more interactive interface elements, wherein the spatial network relationship map comprises a quantum knowledge graph.

5. The system of claim 1, wherein the network anomaly protocol further comprises a particle swarm optimization model configured to scan audit logs, identify signatures and patterns, monitor previous network transmission requests, monitor increases and decreases in network traffic, determine irregular patterns in network packets, and determine a rules criteria threshold associated with rules data.

6. The system of claim 1, wherein executing the computer-readable program code is further configured to cause the at least one processing device to:
receive at least one historical dataset;
train the AI engine based on the at least one historical dataset;
receive network packet vulnerability data;
update the at least one historical dataset with the network packet vulnerability data; and
retrain the AI engine based on the network packet vulnerability data.

7. The system of claim 5, wherein executing the computer-readable program code is further configured to cause the at least one processing device to:
detect, via the AI engine, one or more network anomalies;
segment the one or more network anomalies;
determine, via the AI engine, network anomaly remediations; and
transmit the network anomaly remediations via notification.

8. The system of claim 1, wherein executing the computer-readable program code is further configured to cause the at least one processing device to:
determine, using the AI engine, an alternative network channel associated with the one or more network path transmission requests; and
generate a network path linkage based on the alternative network channel.

9. The system of claim 1 wherein the network channel matrix further comprises a network channel label, network path transmission threshold, last detected anomaly timestamp, security criteria, network channel maintenance timestamp, network channel activity threshold, and network path length.

10. A computer program product for determining network paths and eliminating channel redundancy using artificial intelligence and quantum knowledge graphing, wherein the computer program product comprises at least one non-transitory computer-readable medium having computer-readable program code portion embodied therein, the computer-readable program code portions which when executed by a processing device are configured to cause a processor to:
receive and extract network data from one or more network path transmission requests;
identify network channel requirements based on at least the network data;
execute a network scan based on at least the network channel requirements;
determine a network channel status for one or more network channels based on at least the network channel requirements;
generate a spatial network relationship map based on at least one of the network channel status and the network channel requirements;
execute, using an AI engine, a network anomaly protocol based on at least one of the spatial network relationship map, the network channel status, and the network channel requirements;
generate a network channel matrix based on at least the spatial network relationship map;
determine, using the AI engine, a determined network channel based on the network channel matrix; and
generate and transmit a determined network channel notification.

11. The computer program product of claim 10, wherein the processing device is further configured to:
execute, via the AI engine, an authentication protocol of the one or more network path transmission requests associated with one or more network devices in the determined network channel;
execute, via the AI engine, a geographic verification protocol of the one or more network path transmission requests;
execute, via the AI engine, an encryption protocol of the one or more network path transmission requests;
execute, via the AI engine, a log validation protocol of the one or more network path transmission requests;
execute, via the AI engine, a memory allocation protocol of the of the one or more network path transmission requests;
identify, via the AI engine, an additional network path transmission request associated with the one or more network path transmission requests;
determine, via the AI engine, to intercept the one or more network path transmission requests based on the additional network path transmission request;
generate and transmit an interception notification; and
execute, via the AI engine, a network resource load rebalancing.

12. The computer program product of claim 11, wherein the processing device is further configured to:
verify, using the AI engine, configurations of one or more network devices in the determined network channel;
verify, using the AI engine, certificates associated with the one or more network devices in the determined network channel;
authenticate, using the AI engine, the one or more network devices in the determined network channel via batch authentication;
execute, via the AI engine, network trusted authentication to authenticate the one or more network devices in the determined network channel;
authenticate, using the AI engine, the one or more network devices in the determined network channel via token authentication;
identify, via the AI engine, an execution validation of the authentication protocol; and
generate and transmit an authentication protocol validation message.

13. The computer program product of claim 10, wherein the processing device is further configured to:
generate a user interface on a display;
render one or more interactive interface elements within the user interface, wherein the one or more interactive interface elements comprise the spatial network relationship map; and
receive control signals from at least one device to navigate the one or more interactive interface elements, wherein the spatial network relationship map comprises a quantum knowledge graph.

14. The computer program product of claim 10, wherein the network anomaly protocol further comprises a particle swarm optimization model configured to scan audit logs, identify signatures and patterns, monitor previous network transmission requests, monitor increases and decreases in network traffic, determine irregular patterns in network packets, and determine a rules criteria threshold associated with rules data.

15. The computer program product of claim 10, wherein the network channel matrix further comprises a network channel label, network path transmission threshold, last detected anomaly timestamp, security criteria, network channel maintenance timestamp, network channel activity threshold, and network path length.

16. The computer program product of claim 10, wherein the processing device is further configured to:
determine, using the AI engine, an alternative network channel associated with the one or more network path transmission requests; and
generate a network path linkage based on the alternative network channel.

17. A computer-implemented method for determining network paths and eliminating channel redundancy using artificial intelligence and quantum knowledge graphing:
receiving and extracting network data from one or more network path transmission requests;
identifying network channel requirements based on at least the network data;
executing a network scan based on at least the network channel requirements;
determining a network channel status for one or more network channels based on at least the network channel requirements;
generating a spatial network relationship map based on at least one of the network channel status and the network channel requirements;
executing, using an AI engine, a network anomaly protocol based on at least one of the spatial network relationship map, the network channel status, and the network channel requirements;
generating a network channel matrix based on at least the spatial network relationship map;
determining, using the AI engine, a determined network channel based on the network channel matrix; and
generating and transmitting a determined network channel notification.

18. The computer-implemented method of claim 17, wherein the computer-implemented method is further configured for:
executing, via the AI engine, an authentication protocol of the one or more network path transmission requests associated with one or more network devices in the determined network channel;
executing, via the AI engine, a geographic verification protocol of the one or more network path transmission requests;
executing, via the AI engine, an encryption protocol of the one or more network path transmission requests;
executing, via the AI engine, a log validation protocol of the one or more network path transmission requests;
executing a memory allocation protocol of the of the one or more network path transmission requests;
identifying, via the AI engine, an additional network path transmission request associated with the one or more network path transmission requests;
determining, via the AI engine, to intercept the one or more network path transmission requests based on the additional network path transmission request;
generating and transmitting an interception notification; and
executing, via the AI engine, a network resource load rebalancing.

19. The computer-implemented method of claim 18, wherein the computer-implemented method is further configured for:
verifying, using the AI engine, configurations of one or more network devices in the determined network channel;
verify, using the AI engine, certificates associated with the one or more network devices in the determined network channel;
authenticate, using the AI engine, the one or more network devices in the determined network channel via batch authentication;
execute, via the AI engine, network trusted authentication to authenticate the one or more network devices in the determined network channel;
authenticate, using the AI engine, the one or more network devices in the determined network channel via token authentication;
identify, via the AI engine, an execution validation of the authentication protocol; and
generate and transmit an authentication protocol validation message.

20. The computer-implemented method of claim 17, wherein the computer-implemented method is further configured for:
generating a user interface on a display;
rendering one or more interactive interface elements within the user interface, wherein the one or more interactive interface elements comprise the spatial network relationship map; and
receiving control signals from at least one device to navigate the one or more interactive interface elements, wherein the spatial network relationship map comprises a quantum knowledge graph.
